(19) United States
(12) Patent Application Publication
(10) Pub. No.: US 2017/0184825 A1
(43) Pub. Date: Jun. 29, 2017

(54) ZOOM LENS AND IMAGE PICKUP APPARATUS INCLUDING THE SAME

(71) Applicant: CANON KABUSHIKI KAISHA, Tokyo (JP)

(72) Inventors: Takayoshi Yokoyama, Utsunomiya-shi (JP); Yoshihisa Tashiro, Nikko-shi (JP)

(21) Appl. No.: 15/384,682

(22) Filed: Dec. 20, 2016

(30) Foreign Application Priority Data
Dec. 24, 2015 (JP) 2015-251330

(51) Int. Cl. G02B 15/173; G02B 27/00

(52) U.S. Cl. CPC G02B 15/173; G02B 27/0025

(57) ABSTRACT

A zoom lens includes a first lens unit having a positive refractive power, a second lens unit having a negative refractive power, a third lens unit having a positive refractive power, and a rear lens group having one or more lens units. The first through third lens units and the rear lens group are disposed in this order from an object side to an image side. The first lens unit is stationary when zooming. A reflection member including a reflective surface configured to bend an optical path is disposed in an optical path of the first lens unit. The second lens unit moves in a direction having a component in a direction perpendicular to an optical axis when correcting image blurring. The lateral magnification β2t of the second lens unit when being focused at infinity at a telephoto end is set appropriately.

### BACKGROUND OF THE INVENTION

Field of Invention

The present invention relates to a zoom lens and an image pickup apparatus including the zoom lens. The disclosed zoom lens may be suitable for, for example, a video camera, a digital still camera, a monitoring camera, a silver-halide photography camera, a broadcasting camera, or other imaging devices such as a smartphone, a tablet, a wearable device, and the like.

Description of Related Art

An image pickup optical system for use in an image pickup apparatus is required to be a zoom lens that has a high zoom ratio, that is small in size as a whole, and that, when used in an image pickup apparatus, can reduce the overall thickness of the image pickup apparatus.

A bending-type zoom lens is known in which a reflection member that bends an optical axis of an image pickup optical system by 90°, such as a prism member that uses inner surface reflection, is disposed in an optical path in order to reduce the thickness of an image pickup apparatus. In addition, there is known a zoom lens provided with an image stabilizing function of correcting image blurring by moving a portion of an optical system serving as an image stabilizing lens unit during exposure.

U.S. Pat. No. 8,411,361 and U.S. Pat. No. 7,835,089 each disclose a zoom lens that includes a first lens unit having a positive refractive power, a second lens unit having a negative refractive power, a third lens unit having a positive refractive power, a fourth lens unit having a positive refractive power, and a fifth lens unit having a negative refractive power that are disposed in order from an object side to an image side, and a reflection member for bending an optical path is disposed in the first lens unit. In such zoom lenses, the first lens unit is stationary when zooming, and the second lens unit moves so as to have a component in a direction perpendicular to the optical axis when correcting image blurring.

### SUMMARY OF THE INVENTION

The present invention provides a zoom lens that includes a first lens unit having a positive refractive power, a second lens unit having a negative refractive power, a third lens unit having a positive refractive power, and a rear lens group having one or more lens units, and the first through third lens units and the rear lens group are disposed in this order from an object side to an image side of the zoom lens. The first lens unit is stationary when zooming, and the distance between adjacent lens units changes when zooming. A reflection member including a reflective surface configured to bend an optical path is disposed in an optical path of the first lens unit. The second lens unit moves in a direction having a component in a direction perpendicular to an optical axis when correcting image blurring. A conditional expression −2.50<β2t<−0.98 is satisfied, in which β2t represents a lateral magnification of the second lens unit when being focused at infinity at a telephoto end.

Further features of the present invention will become apparent from the following description of exemplary embodiments with reference to the attached drawings.

### BRIEF DESCRIPTION OF THE DRAWINGS

FIG. 1 is a sectional view at a wide angle end of a zoom lens, according to a first exemplary embodiment.

FIGS. 2A, 2B, and 2C are longitudinal aberration diagrams at a wide angle end, an intermediate zoom position, and a telephoto end, respectively, when the zoom lens is being focused on an object at infinity, according to the first exemplary embodiment.

FIGS. 3A, 3B, and 3C are lateral aberration diagrams of image stabilization correction of the zoom lens at a wide angle end, an intermediate zoom position, and a telephoto end, respectively, when the zoom lens is being focused on an object at infinity, according to the first exemplary embodiment.

FIG. 4 is a sectional view of a zoom lens at a wide angle end, according to a second exemplary embodiment.

FIGS. 5A, 5B, and 5C are longitudinal aberration diagrams at a wide angle end, an intermediate zoom position, and a telephoto end, respectively, when the zoom lens is being focused on an object at infinity, according to the second exemplary embodiment.

FIGS. 6A, 6B, and 6C are lateral aberration diagrams of image stabilization correction at a wide angle end, an intermediate zoom position, and a telephoto end, respectively, when the zoom lens is being focused on an object at infinity, according to the second exemplary embodiment.

FIG. 7 is a sectional view of a zoom lens at a wide angle end, according to a third exemplary embodiment.

FIGS. 8A, 8B, and 8C are longitudinal aberration diagrams at a wide angle end, an intermediate zoom position, and a telephoto end, respectively, when the zoom lens is being focused on an object at infinity, according to the third exemplary embodiment.

FIGS. 9A, 9B, and 9C are lateral aberration diagrams of image stabilization correction at a wide angle end, an intermediate zoom position, and a telephoto end, respectively, when the zoom lens is being focused on an object at infinity, according to the third exemplary embodiment.

FIG. 10 is a sectional view at a wide angle end of a zoom lens, according to a fourth exemplary embodiment.

FIGS. 11A, 11B, and 11C are longitudinal aberration diagrams at a wide angle end, an intermediate zoom position, and a telephoto end, respectively, when the zoom lens is being focused on an object at infinity, according to the fourth exemplary embodiment.

FIGS. 12A, 12B, and 12C are lateral aberration diagrams of image stabilization correction at a wide angle end, an intermediate zoom position, and a telephoto end, respectively, when the zoom lens is being focused on an object at infinity, according to the fourth exemplary embodiment.

FIG. 13 is a sectional view taken along a plane perpendicular to that shown in FIG. 1 at a wide angle end of the zoon lens, according to the first exemplary embodiment of the present invention.

FIG. 14 is a schematic diagram of an image pickup apparatus including a zoom lens, according to an exemplary embodiment of the present invention.

### DESCRIPTION OF THE EMBODIMENTS

A zoom lens and an image pickup apparatus including the zoom lens according to exemplary embodiments of the present invention are now described in detail. The zoom lens according to an exemplary embodiment of the present invention includes a first lens unit having a positive refractive power, a second lens unit having a negative refractive power, a third lens unit having a positive refractive power, and a rear lens group having one or more lens units, and the first through third lens units and the rear lens group are disposed in order from an object side to an image side. The first lens unit is stationary when zooming, and the distance between adjacent lens units changes when zooming. A reflection member including a reflective surface configured to bend an optical path is disposed in an optical path of the first lens unit, and the second lens unit moves in a direction having a component in a direction perpendicular to an optical axis when correcting image blurring.

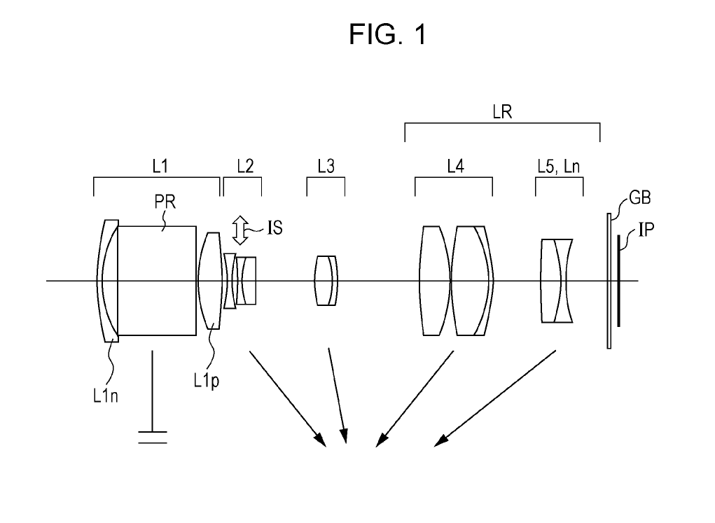

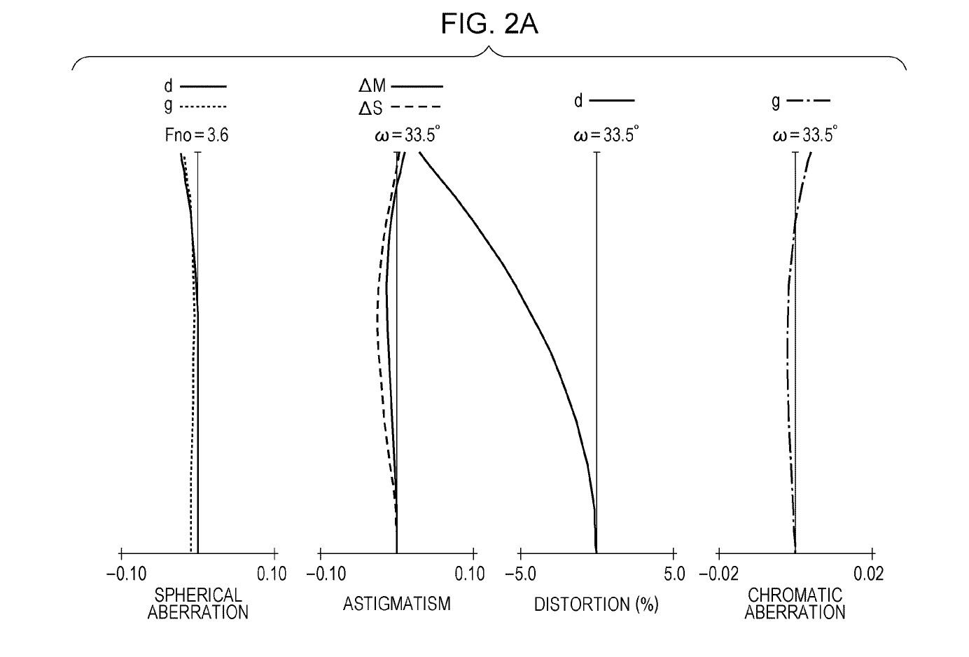

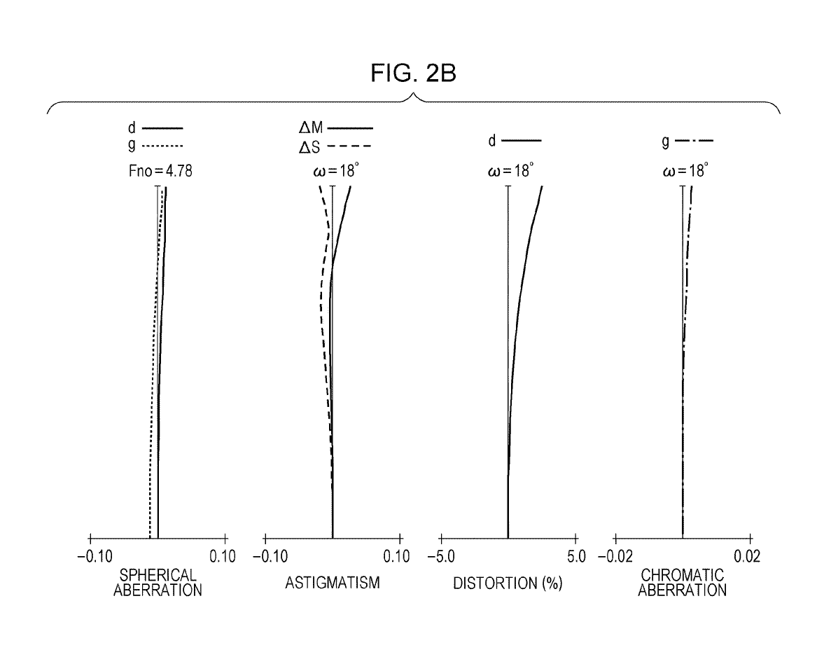

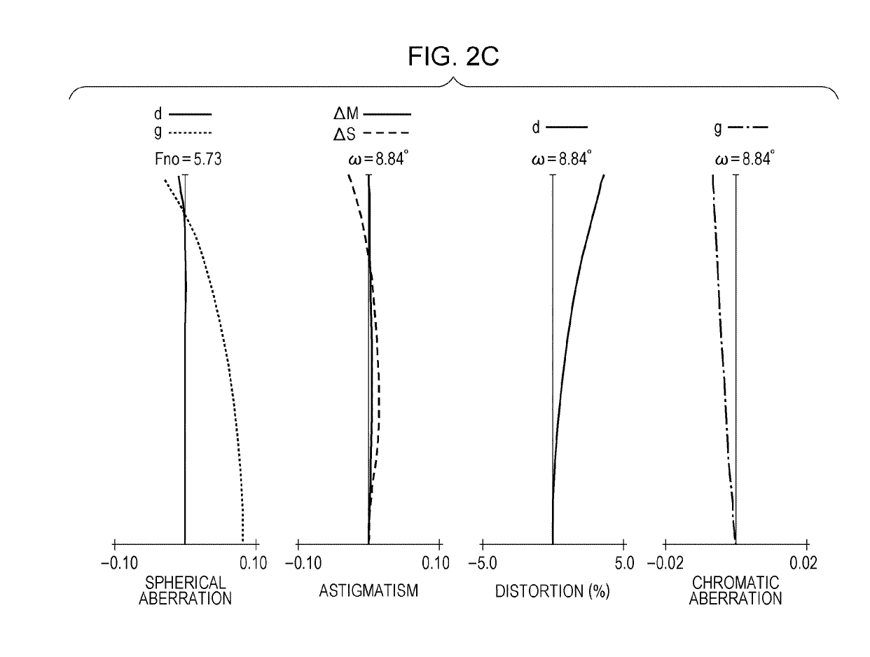

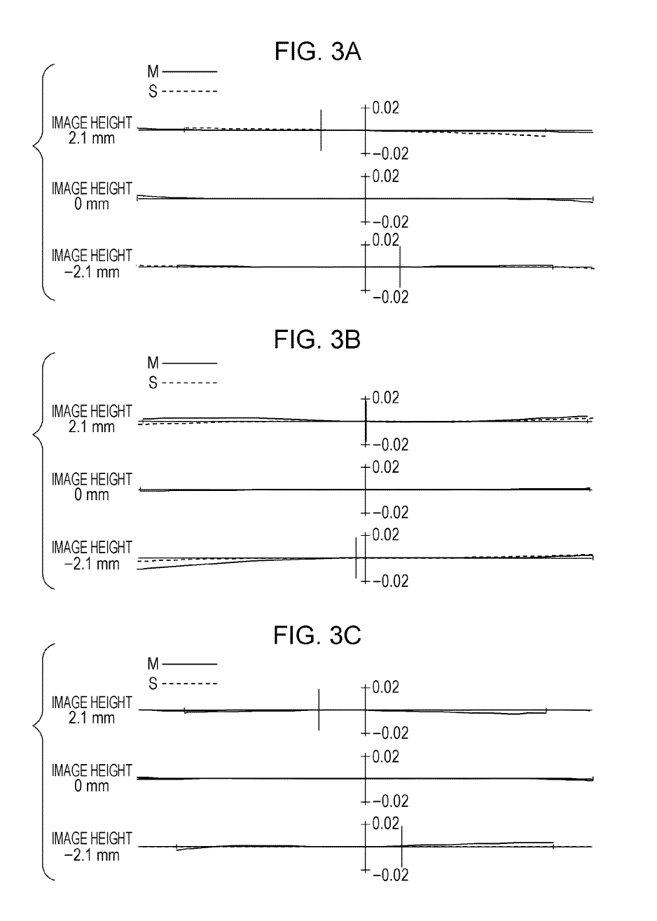

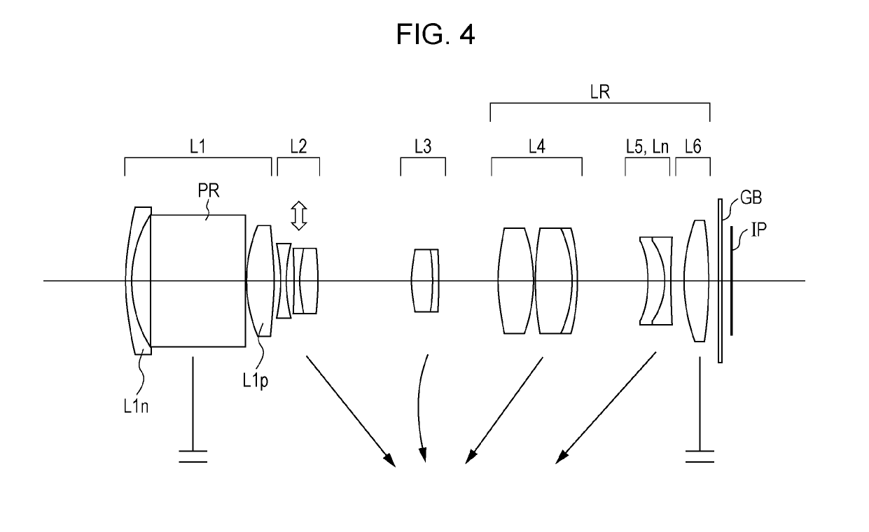

FIG. 1 is a sectional view of a zoom lens at a wide angle end (short focal length end), according to a first exemplary embodiment of the present invention. FIGS. 2A, 2B, and 2C are aberration diagrams of the zoom lens at a wide angle end, an intermediate zoom position, and a telephoto end (long focal length end), respectively, when the zoom lens is being focused on an object at infinity. FIGS. 3A, 3B, and 3C are lateral aberration diagrams of the zoom lens at the time of image stabilization correction at a wide angle end, an intermediate zoom position, and a telephoto end, respectively, when being focused at infinity. The first exemplary embodiment provides a zoom lens having a zoom ratio of 4.73 and an F-number of 3.60 to 5.73.

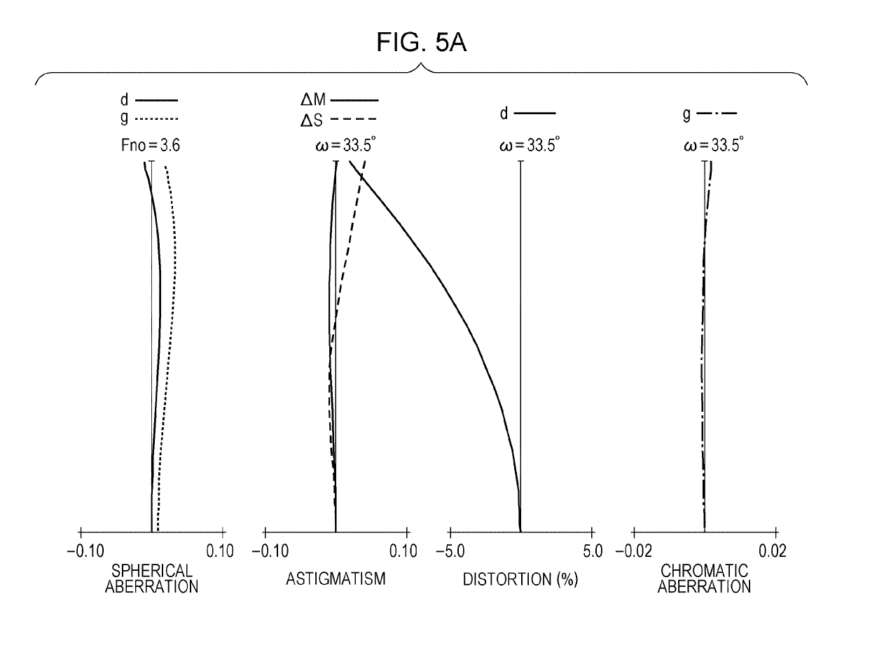

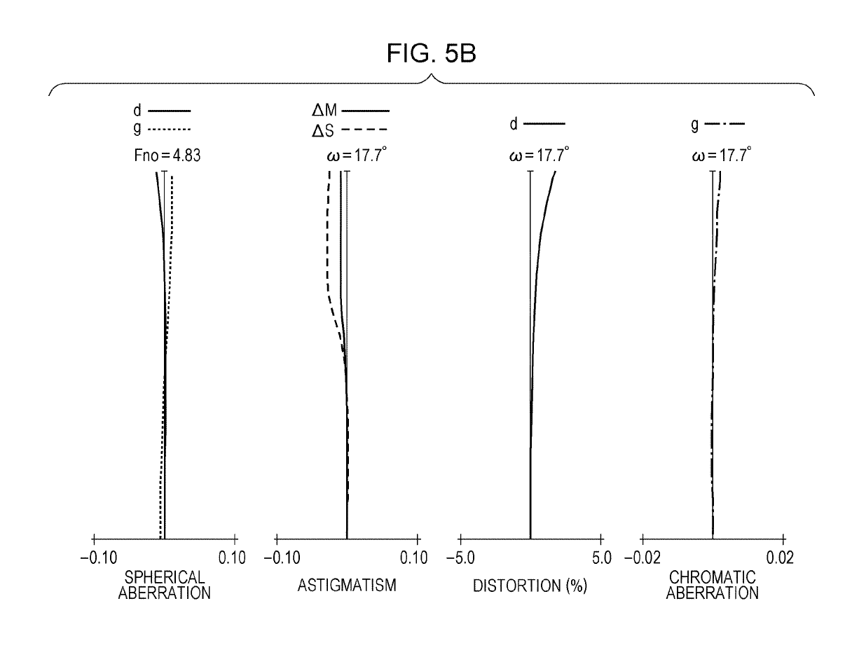

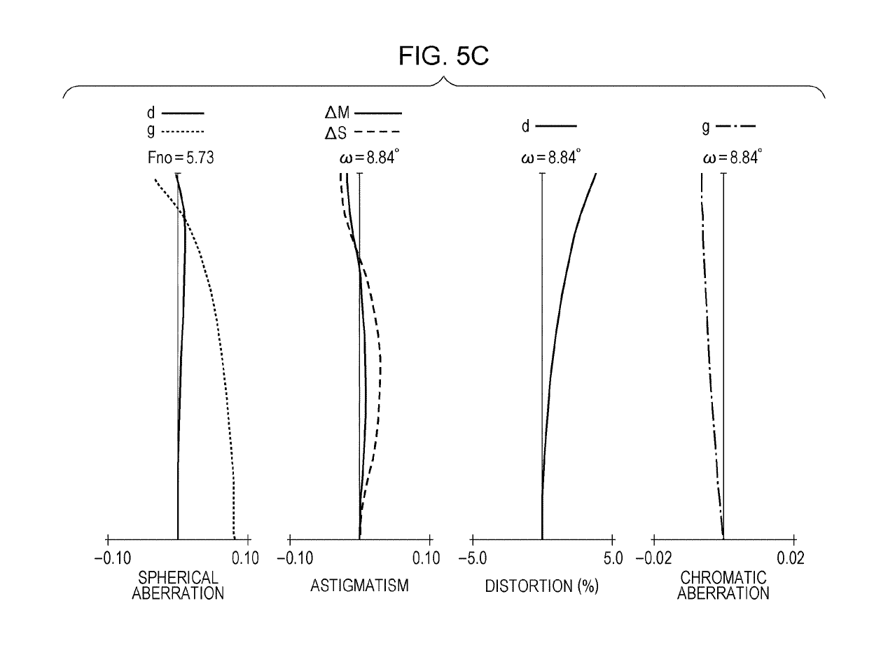

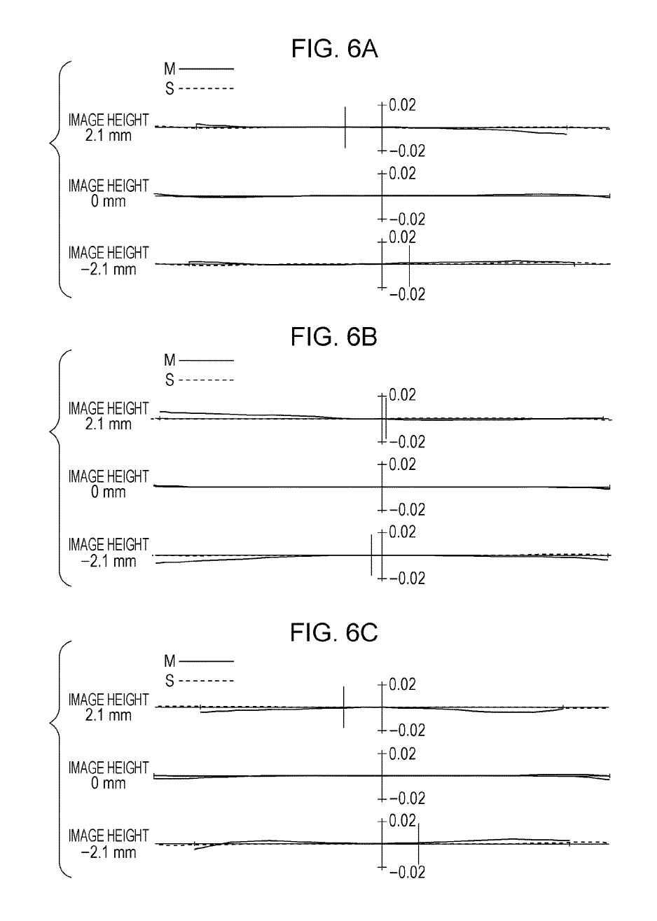

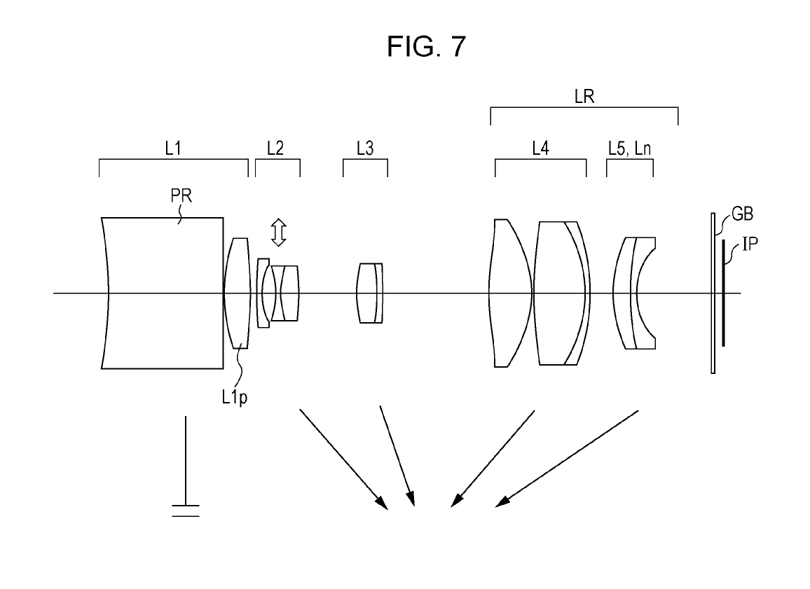

FIG. 4 is a lens sectional view of a zoom lens according to a second exemplary embodiment of the present invention at a wide angle end. FIGS. 5A, 5B, and 5C are aberration diagrams of the zoom lens according to the second exemplary embodiment at a wide angle end, an intermediate zoom position, and a telephoto end, respectively, when being focused at infinity. FIGS. 6A, 6B, and 6C are lateral aberration diagrams of the zoom lens according to the second exemplary embodiment at the time of image stabilization correction at a wide angle end, an intermediate zoom position, and a telephoto end, respectively, when being focused at infinity. The second exemplary embodiment provides a zoom lens having a zoom ratio of 4.73 and an F-number of 3.60 to 5.73.

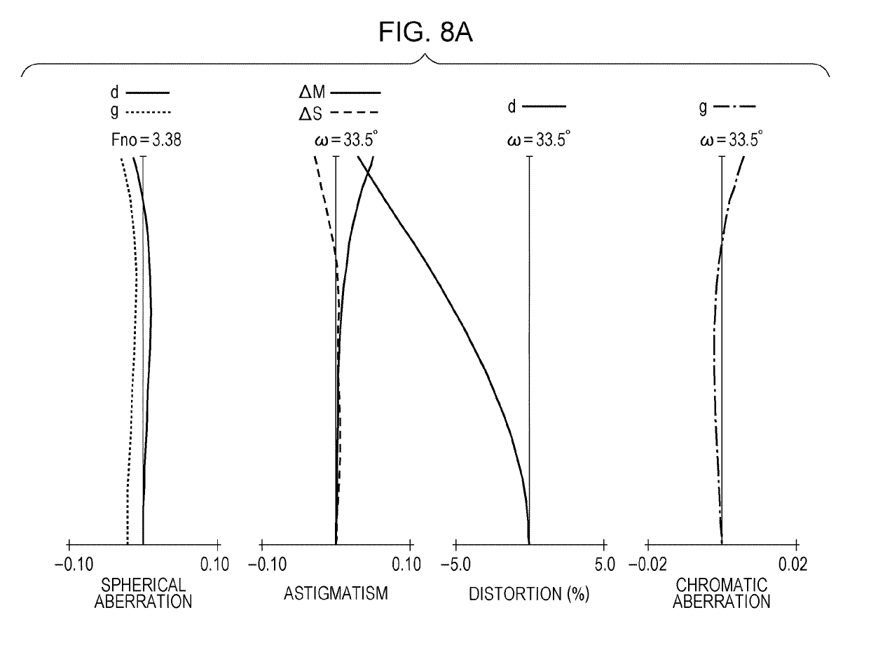

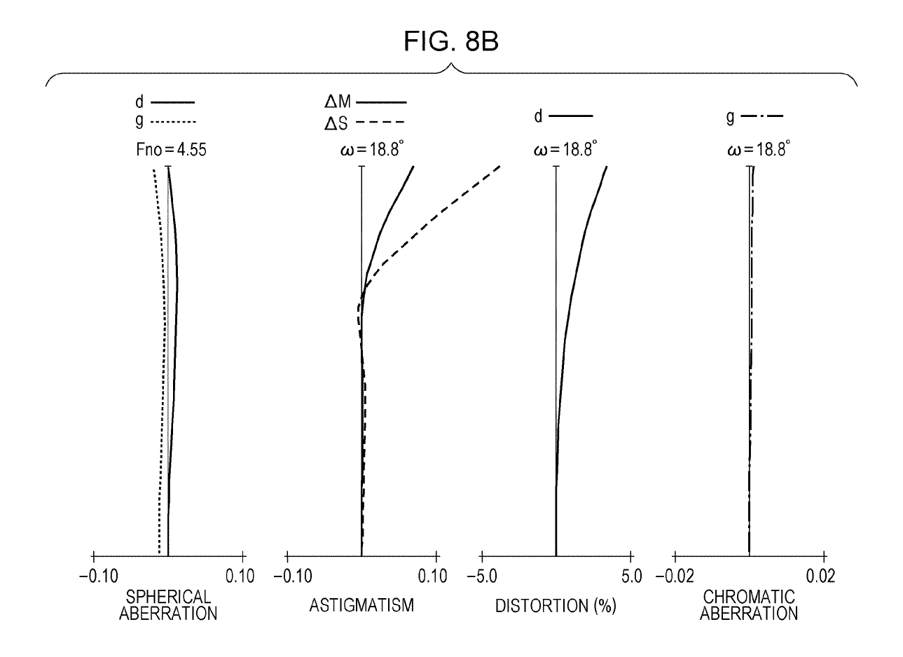

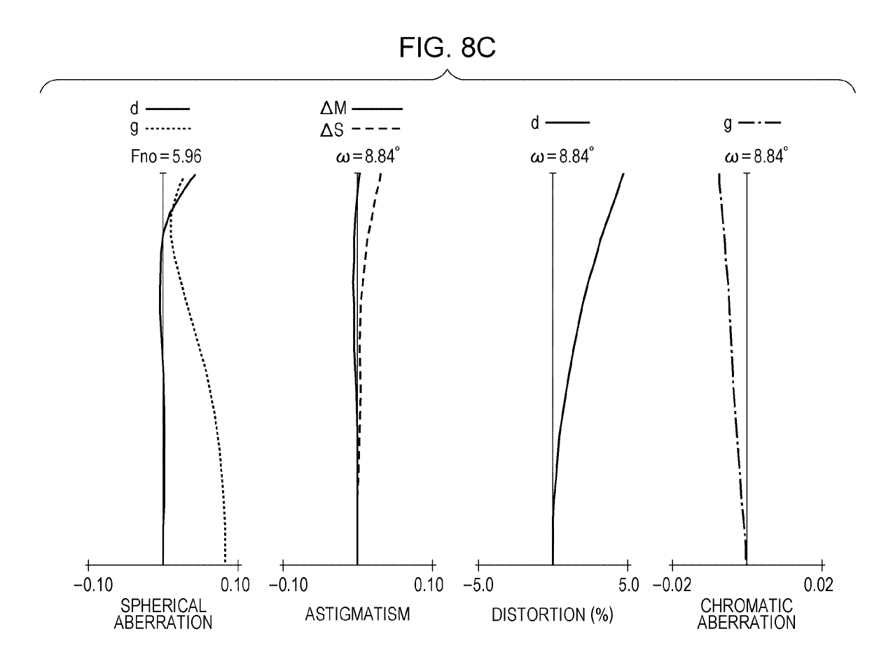

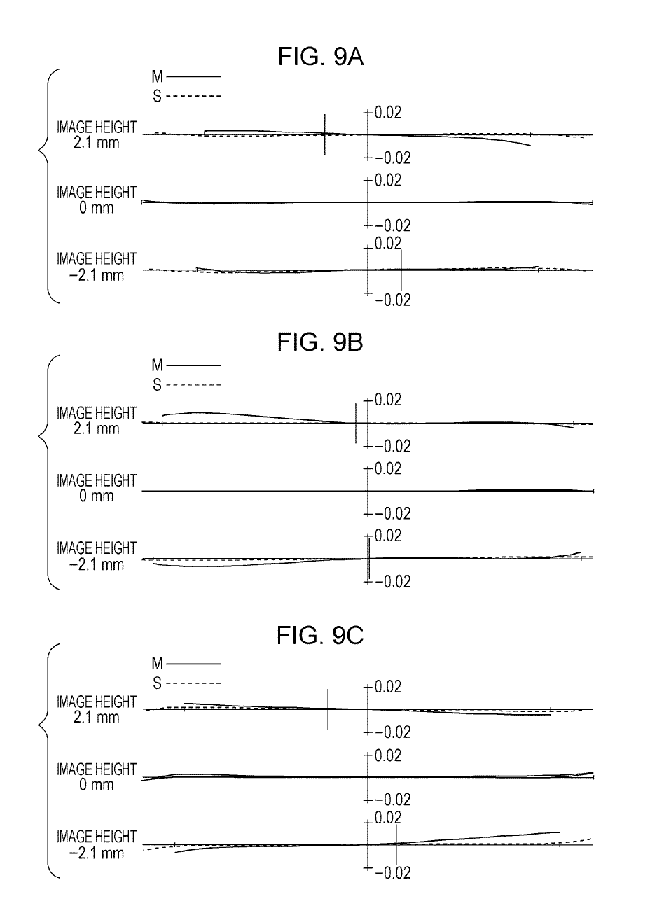

FIG. 7 is a lens sectional view of a zoom lens according to a third exemplary embodiment of the present invention at a wide angle end. FIGS. 8A, 8B, and 8C are aberration diagrams of the zoom lens according to the third exemplary embodiment at a wide angle end, an intermediate zoom position, and a telephoto end, respectively, when being focused at infinity. FIGS. 9A, 9B, and 9C are lateral aberration diagrams of the zoom lens according to the third exemplary embodiment at the time of image stabilization correction at a wide angle end, an intermediate zoom position, and a telephoto end, respectively, when being focused at infinity. The third exemplary embodiment provides a zoom lens having a zoom ratio of 4.73 and an F-number of 3.38 to 5.96.

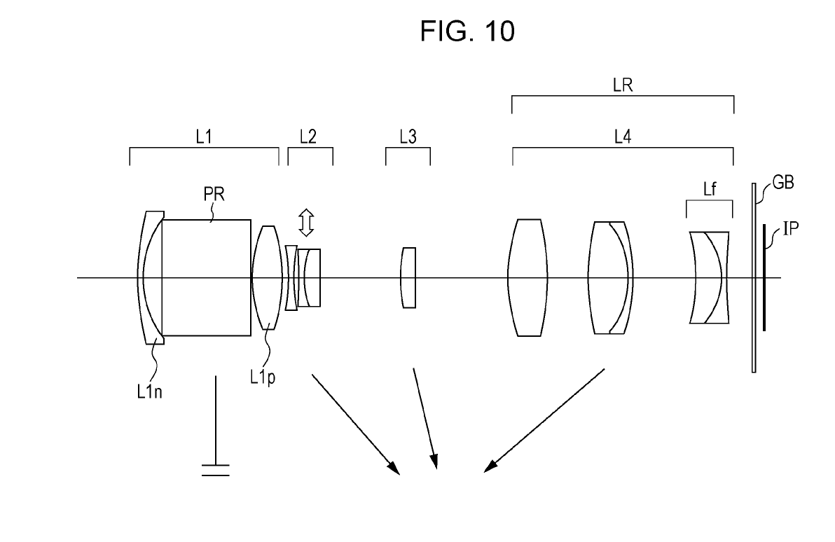

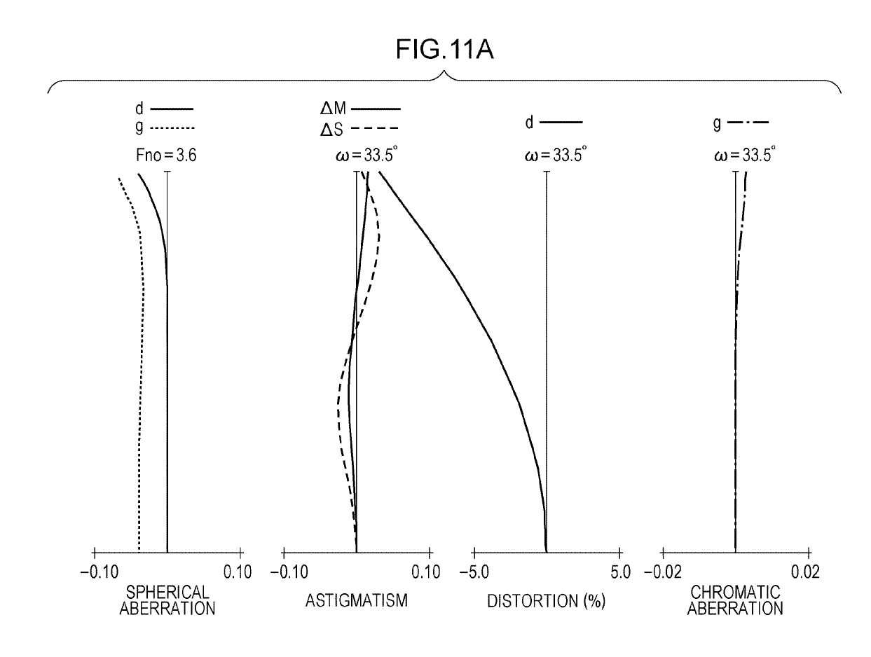

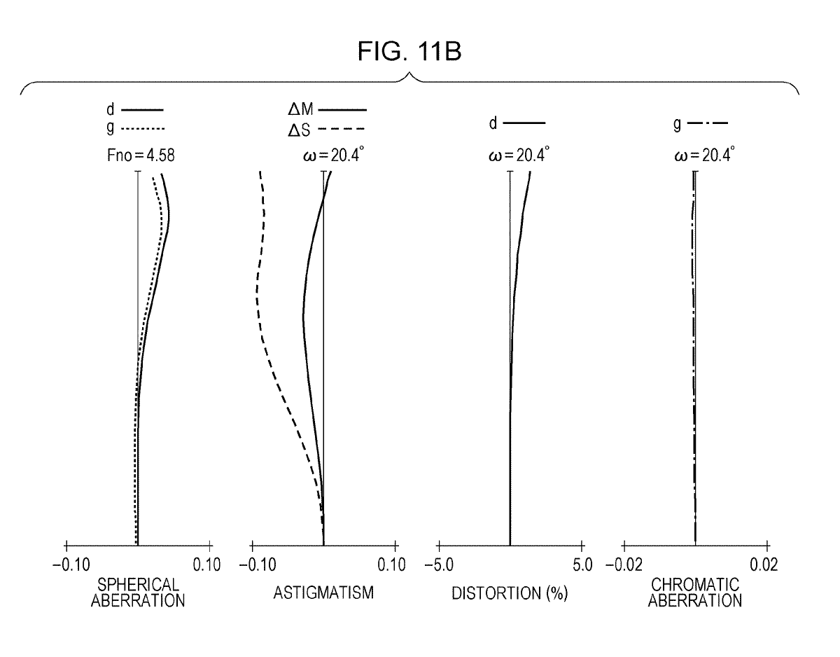

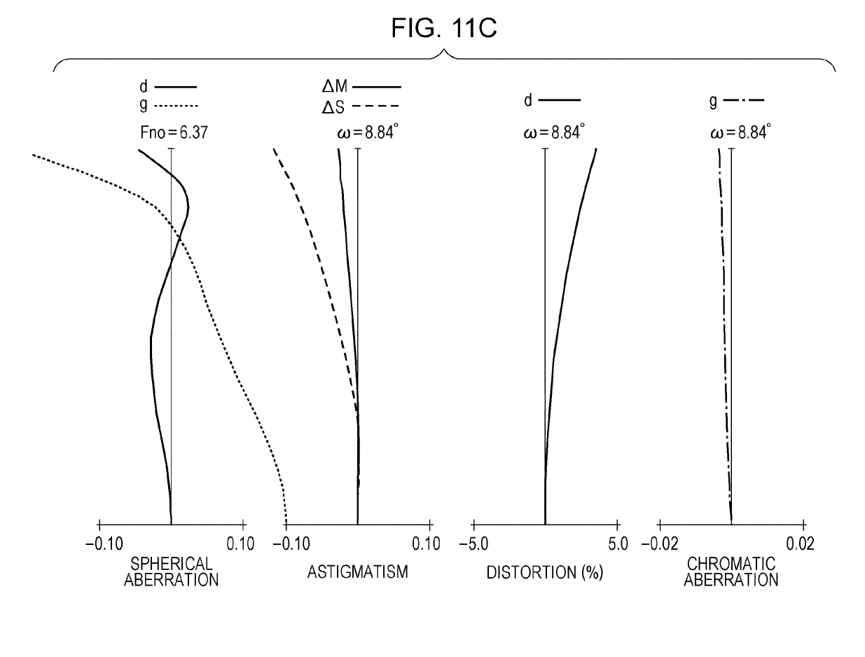

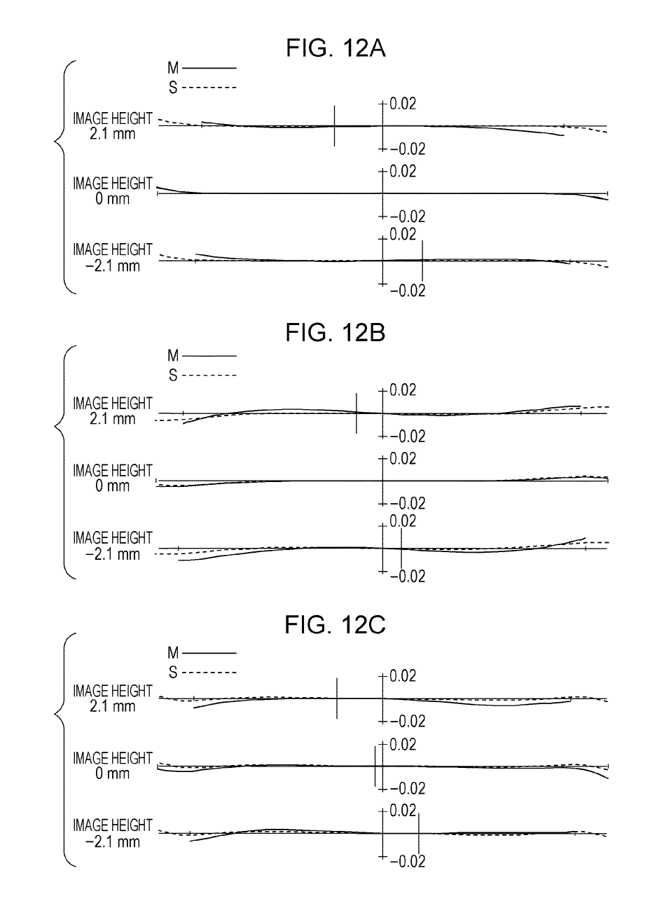

FIG. 10 is a lens sectional view of a zoom lens according to a fourth exemplary embodiment of the present invention at a wide angle end. FIGS. 11A, 11B, and 11C are aberration diagrams of the zoom lens according to the fourth exemplary embodiment at a wide angle end, an intermediate zoom position, and a telephoto end, respectively, when being focused at infinity. FIGS. 12A, 12B, and 12C are lateral aberration diagrams of the zoom lens according to the fourth exemplary embodiment at the time of image stabilization correction at a wide angle end, an intermediate zoom position, and a telephoto end, respectively, when being focused at infinity. The fourth exemplary embodiment provides a zoom lens having a zoom ratio of 4.73 and an F-number of 3.60 to 6.37.

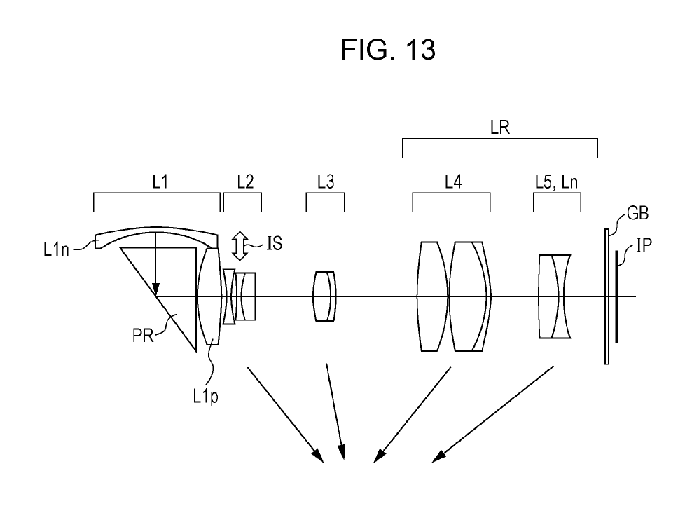

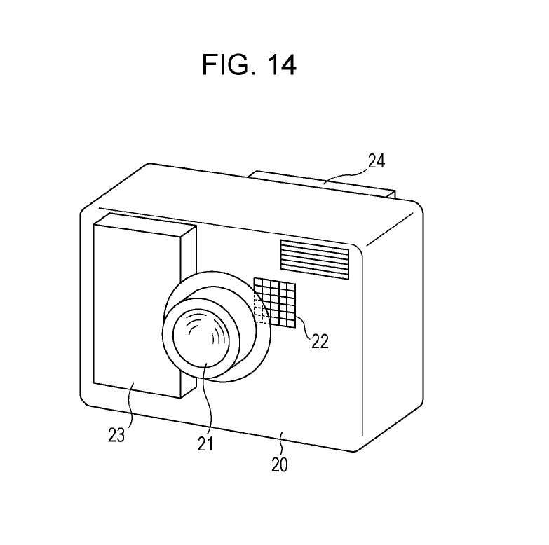

Although the optical path is bent by a reflection member (prism) having a reflective surface provided within the prism in each of the lens sectional views illustrated in FIGS. 1, 4, 7, and 10, each lens sectional view illustrates the optical path in a developed manner for convenience. FIG. 13 is a lens sectional view of the zoom lens according to the first exemplary embodiment in a state in which the optical path is bent by the reflection member at a wide angle end. FIG. 14 is a schematic diagram of a primary portion of a camera (image pickup apparatus) including a zoom lens according to an exemplary embodiment of the present invention.

The zoom lens according to each of the exemplary embodiments is an image pickup optical system to be used in an image pickup apparatus, such as a video camera, a digital camera, and a silver-halide film camera. In each lens sectional view, the left side corresponds to the side of an object (object side) (front side), and the right side corresponds to the image side (rear side). In each lens sectional view, i indicates the order of a given lens unit counted from the object side, and Li represents an ith lens unit.

The reference character LR denotes a rear lens group that includes one or more lens units. The reference character Ln denotes a lens unit having a negative refractive power included in the rear lens group LR. The reference character PR denotes a reflection member for bending an optical path, and the reflection member PR includes a reflective surface and is constituted by a prism (a glass material or a plastic material) that bends an optical path by 90 degrees or around 90 degrees (90 degrees±10 degrees) in each of the exemplary embodiments. The reference character GB denotes an optical block corresponding to an optical filter, a face plate, a crystal low pass filter, an infrared cut-off filter, or the like.

The reference character IP denotes an image plane. An image pickup surface of a solid-state image pickup element (photoelectric conversion element), such as a charge-coupled device (CCD) sensor or a complementary metal-oxide semiconductor (CMOS) sensor, is placed at the image plane IP when the zoom lens is used as an image pickup optical system in a video camera or a digital still camera, or a photosensitive surface corresponding to a film surface is placed at the image plane IP when the zoom lens is used in a silver-halide film camera.

A lens barrel frame in the third lens unit L3 on the side closest to the object side also serves as an aperture stop. It is to be noted that the aperture stop may be disposed on the object side of the third lens unit L3. In each lens sectional view, the arrows indicate the movement loci of the lens units and of an aperture stop SP when zooming from a wide angle end to a telephoto end.

Of the aberration diagrams, in the spherical aberration diagrams, d indicated by a solid line represents the d-line (wavelength of 587.6 nm), and g indicated by a dotted line represents the g-line (wavelength of 435.8 nm). In the astigmatism diagrams, ΔM indicated by a solid line represents a meridional image plane at the d-line, and ΔS indicated by a dashed line represents a sagittal image plane at the d-line. In the chromatic aberration, g indicated by a dashed-dotted line represents the g-line. In addition, ω represents a half angle of view (a value representing a half of the shooting angle of view) (degree), and Fno represents the F-number. In the lateral aberration diagrams, M indicated by a solid line represents a meridional image plane, and S indicated by a dashed line represents a sagittal image plane. It is to be noted that, in each of the following exemplary embodiments, a wide angle end and a telephoto end refer to the zoom positions held when lens units for varying the magnification are located at respective ends of a range within which the lens units can move mechanically along the optical axis.

A zoom lens according to an exemplary embodiment of the present invention includes a first lens unit L1 having a positive refractive power, a second lens unit L2 having a negative refractive power, a third lens unit L3 having a positive refractive power, and a rear lens group LR having one or more lens units, and the first through third lens units L1 through L3 and the rear lens group LR are disposed in order from the object side to the image side. A zoom lens according to an exemplary embodiment of the present invention employs a positive lead type refractive power arrangement and achieves a high zoom ratio and a reduction of the effective diameter of the front lens (effective diameter of the first lens unit L1) at the same time.

The first lens unit L1 is stationary when zooming to reduce the number of movable lens units, and the lens barrel structure is simplified to reduce the size of the lens units in the image pickup apparatus. In addition, the first lens unit L1 is made stationary, and the lens units are formed to have a closed structure. Thus, an image pickup apparatus with a strength against an external disturbance is achieved. A reflection member PR having a reflective surface is disposed in an optical path of the first lens unit L1, which is disposed closest to the object side, and the optical axis is bent by about 90 degrees (within 90 degrees±10 degrees). Thus, a reduction in the thickness of the image pickup apparatus as a whole is achieved.

The image blurring correction (image stabilization) is achieved with the second lens unit L2, which is a main magnification varying lens unit of the positive lead type zoom lens. Specifically, to achieve image blurring correction (image stabilization), the second lens unit L2 moves in a direction having a component in a direction perpendicular to an optical axis when correcting image blurring. In FIG. 1, the double arrow labeled IS shows the second lens unit L2 moves in a direction having a component in a direction perpendicular to an optical axis. The refractive power of each lens unit is arranged such that the lateral magnification of the second lens unit L2 at a telephoto end when being focused at infinity becomes the equal magnification or higher, making it easier to increase the image stabilization sensitivity while achieving a high zoom ratio.

With this configuration, the amount of movement IS of the second lens unit L2 during image blurring correction is reduced, and the thickness of the zoom lens provided with an image stabilizing function is reduced. In addition, a light beam converged by the first lens unit L1 having a positive refractive power is made to be incident on the second lens unit L2. Thus, the lens effective diameter of the second lens unit L2 is reduced, and the size of the image stabilizing mechanism is reduced, making it easier to reduce the thickness of the zoom lens.

In each of the exemplary embodiments, the lateral magnification of the second lens unit L2 when being focused at infinity at a telephoto end is represented by β2t. In this case, the following conditional expression (1) is satisfied.

−2.50<β2t<−0.98 (1)

The conditional expression (1) is for reducing the overall size of the zoom lens while achieving a high zoom ratio. When β2t falls below the lower limit value of the conditional expression (1), the image stabilization sensitivity becomes too high. Therefore, the driving control during the image blurring correction becomes difficult. In addition, the diverging effect of the second lens unit L2 becomes too strong, and thus the lens effective diameter of the rear lens group LR increases, and it becomes difficult to reduce the thickness of the zoom lens.

When β2t exceeds the upper limit value of the conditional expression (1), the magnification varying burden of the second lens unit L2, which is the main magnification varying lens unit, becomes too small, and thus the magnification varying effect of the rear lens group LR needs to be increased in order to achieve a high zoom ratio. In that case, the amount of movement of the lens unit(s) constituting the rear lens group LR when zooming increases, and the length of an optical path in the lengthwise direction after the optical path is bent by the reflective surface in the first lens unit L1 increases, leading to an increase in the size of the entire image pickup apparatus. In addition, the image stabilization sensitivity of the second lens unit L2 is reduced, and the amount of movement of the second lens unit L2 when correcting image blurring increases, making it difficult to reduce the thickness of the entire image pickup apparatus.

More preferably, the numerical range of the conditional expression (1) is set to the following range.

−2.00<β2t<−1.02 (1a)

Even more preferably, the numerical range of the conditional expression (1a) is set to the following range.

−1.80<β2t<−1.05 (1b)

With the configuration described above, the zoom lens according to an exemplary embodiment of the present invention can be a zoom lens that has high optical performance, that can reduce the size of the image pickup apparatus as a whole with ease, and that is provided with an image stabilizing function. In each of the exemplary embodiments, it is more preferable that one or more of the following conditional expressions be satisfied.

The distance from a lens surface of the second lens unit L2 that is closest to the image side at a wide angle end to a lens surface of the third lens unit L3 that is closest to the object side along the optical axis is represented by D23w. The focal length of the zoom lens at a wide angle end is represented by fw. The distance from a lens surface of the first lens unit L1 that is closest to the object side to a lens surface of the first lens unit L1 that is closest to the image side along the optical axis is represented by D1. The focal length of the zoom lens at a telephoto end is represented by ft. The focal length of the first lens unit L1 is represented by f1. The focal length of the second lens unit L2 is represented by f2. The lateral magnification of the second lens unit L2 when being focused at infinity at a wide angle end is represented by β2w. In addition, Z2=β2t/β2w and Z=ft/fw hold true.

The first lens unit L1 is constituted by a lens component having a negative refractive power, a reflection member, and a lens component having a positive refractive power that are disposed in order from the object side to the image side or is constituted by a reflection member having a negative refractive power and a lens component having a positive refractive power that are disposed in order from the object side to the image side. Here, a lens component includes a single lens, a plurality of lenses, or a cemented lens in which a plurality of lenses are cemented. The reflection member PR is constituted by a prism that utilizes total reflection. The focal length of the lens component having a negative refractive power is represented by fGn. The length of the prism along the optical axis is represented by Dpr. The refractive index of the material for the prism at the d-line is represented by Ndpr. The focal length of the lens unit Ln having a negative refractive power included in the rear lens group LR is represented by fn. In this case, it is desirable that one or more of the following conditional expressions be satisfied.

0.50<D23w/fw<1.50 (2)

0.20<D1/ft<0.50 (3)

2.00<f1/fw<3.00 (4)

−1.30<f2/fw<−0.60 (5)

0.46<Z2/Z<0.72 (6)

−3.50<fGn/Dpr<−1.20 (7)

1.80<Ndpr<2.50 (8)

−0.53<fn/ft<−0.17 (9)

Next, the technical meaning of each of the conditional expressions above will be described. The conditional expression (2) relates to a reduction in the thickness of the zoom lens. When the thickness of the zoom lens is reduced by disposing a reflection member in an optical path of the first lens unit L1 and by bending the optical path, the lens unit thickness of the first lens unit L1 increases in order to prevent interference between the reflection member and each of the lenses that constitute the first lens unit L1. In addition, in the positive lead type zoom lens in which the first lens unit L1 is stationary when zooming, the amount of movement of the second lens unit L2, which is the main magnification varying lens unit, increases when zooming.

As a result, the distance between the aperture stop of the rear lens group LR disposed close to the object side and the first lens unit L1 increases. In that case, the effective diameter of the first lens unit L1 tends to increase as compared to a case of a zoom lens that does not include a reflection member. Therefore, the first lens unit L1, the second lens unit L2, the third lens unit L3, and the rear lens group LR need to be disposed appropriately. When D23w/fw falls below the lower limit value of the conditional expression (2) and the magnification varying burden of the second lens unit L2 becomes too small, the amount of movement of the lens unit(s) constituting the rear lens group LR increases in order to achieve a high zoom ratio.

Furthermore, although it becomes easier to reduce the size of the first lens unit L1, the lens effective diameter of the rear lens group LR increases, and it becomes difficult to reduce the thickness of the zoom lens. When D23w/fw exceeds the upper limit value of the conditional expression (2) and the effective diameter of the first lens unit L1 becomes too large, it becomes difficult to reduce the thickness of the zoom lens.

More preferably, the numerical range of the conditional expression (2) is set to the following range.

0.60<D23w/fw<1.40 (2a)

Even more preferably, the numerical range of the conditional expression (2a) is set to the following range.

0.65<D23w/fw<1.23 (2b)

The conditional expression (3) is for defining the distance (lens unit thickness) from the lens surface closest to the object side to the lens surface closest to the image side in the first lens unit L1 along the optical axis. When D1/ft falls below the lower limit value of the conditional expression (3) and the lens unit thickness of the first lens unit L1 becomes too small, it becomes difficult to dispose the reflection member for bending the optical path in the first lens unit L1. When D1/ft exceeds the upper limit value of the conditional expression (3) and the lens unit thickness of the first lens unit L1 becomes too large, the thickness of the image pickup apparatus when the zoom lens is applied to the image pickup apparatus increases.

More preferably, the numerical range of the conditional expression (3) is set to the following range.

0.25<D1/ft<0.47 (3a)

Even more preferably, the numerical range of the conditional expression (3a) is set to the following range.

0.30<D1/ft<0.47 (3b)

The conditional expression (4) is for defining the focal length of the first lens unit L1. When f1/fw falls below the lower limit value of the conditional expression (4) and the focal length of the first lens unit L1 becomes too short, the on-axis chromatic aberration and the chromatic aberration of magnification increase at a telephoto end, and it becomes difficult to correct these aberrations. When f1/fw exceeds the upper limit value of the conditional expression (4) and the focal length of the first lens unit L1 becomes too long, the effective diameter of the first lens unit L1 increases when the first lens unit L1 is made to be stationary when zooming.

More preferably, the numerical range of the conditional expression (4) is set to the following range.

2.05<f1/fw<2.80 (4a)

Even more preferably, the numerical range of the conditional expression (4a) is set to the following range.

2.10<f1/fw<2.60 (4b)

The conditional expression (5) is for defining the focal length of the second lens unit L2. When f2/fw falls below the lower limit value of the conditional expression (5) and the negative focal length of the second lens unit L2 becomes too long (the absolute value of the negative focal length becomes too large), the amount of movement of the second lens unit L2 increases when zooming, and the total lens length increases. When f2/fw exceeds the upper limit value of the conditional expression (5) and the negative focal length of the second lens unit L2 becomes too short (the absolute value of the negative focal length becomes too small), a variation in the curvature of field increases, and it becomes difficult to correct this variation in the curvature of field.

More preferably, the numerical range of the conditional expression (5) is set to the following range.

−1.20<f2/fw<−0.70 (5a)

Even more preferably, the numerical range of the conditional expression (5a) is set to the following range.

−1.10<f2/fw<−0.80 (5b)

The conditional expression (6) relates to the magnification varying burden of the second lens unit L2. When Z2/Z falls below the lower limit value of the conditional expression (6) and the magnification varying burden of the second lens unit L2 becomes too small, the amount of movement of the lens unit(s) constituting the rear lens group LR when zooming increases in order to achieve a high zoom ratio, and the size of the camera in the lengthwise direction increases. When Z2/Z exceeds the upper limit value of the conditional expression (6) and the negative refractive power of the second lens unit L2 becomes too large (the absolute value of the negative refractive power becomes too large), it becomes difficult to correct a variation in the curvature of field in the entire zoom range. Alternatively, the amount of movement of the second lens unit L2 when zooming increases, and it becomes difficult to reduce the thickness of the zoom lens.

More preferably, the numerical range of the conditional expression (6) is set to the following range.

0.48<Z2/Z<0.70 (6a)

Even more preferably, the numerical range of the conditional expression (6a) is set to the following range.

0.50<Z2/Z<0.67 (6b)

In each of the exemplary embodiments, it is desirable that the first lens unit L1 be constituted by a lens component L1n having a negative refractive power, a reflection member PR, and a lens component Lip having a positive refractive power that are disposed in order from the object side to the image side. By disposing the lens component L1n having a negative refractive power on the object side of the reflection member PR, when the imaging angle of view at a wide angle end is to be increased in order to achieve a high zoom ratio, it becomes easier to reduce the lens effective diameter of the first lens unit L1.

In a case in which the reflection member PR is constituted by a prism that utilizes total reflection, the lens surface of the prism on the object side may be made to be a concave surface so as to serve as a lens component having a negative refractive power. By employing a configuration in which a lens component having a negative refractive power is disposed on the object side of the prism, it becomes even easier to reduce the thickness of the zoom lens.

The conditional expression (7) relates to a reduction in the size of the first lens unit L1. When fGn/Dpr falls below the lower limit value of the conditional expression (7) and the negative refractive power of the lens component L1n having a negative refractive power becomes too small, the size of the first lens unit L1 increases, and it becomes difficult to reduce the thickness of the zoom lens. When fGn/Dpr exceeds the upper limit value of the conditional expression (7) and the negative refractive power of the lens component L1n having a negative refractive power becomes too large, the spherical aberration and the on-axis chromatic aberration increase at a telephoto end.

More preferably, the numerical range of the conditional expression (7) is set to the following range.

−3.30<fGn/Dpr<−1.35 (7a)

Even more preferably, the numerical range of the conditional expression (7a) is set to the following range.

−3.10<fGn/Dpr<−1.50 (7b)

The conditional expression (8) is for defining the refractive index of the material for the reflection member PR disposed in the optical path of the first lens unit L1. When Ndpr falls below the lower limit value of the conditional expression (8) and the refractive index of the material for the reflection member PR becomes too small, the size of the reflection member PR with the air-equivalent length kept constant increases, and the thickness of the image pickup apparatus when the zoom lens is applied to the image pickup apparatus increases. When Ndpr exceeds the upper limit value of the conditional expression (8) and the refractive index of the material for the reflection member PR becomes too large, an optical material having a refractive index that exceeds the upper limit value typically tends to have an extremely low transmittance at a shorter wavelength side. Therefore, it becomes difficult to maintain a good color balance to serve as an image pickup apparatus.

More preferably, the numerical range of the conditional expression (8) is set to the following range.

1.90<Ndpr<2.50 (8a)

Even more preferably, the numerical range of the conditional expression (8a) is set to the following range.

2.00<Ndpr<2.50 (8b)

In order to reduce the size of the image pickup apparatus, it is desirable to include a lens unit Ln having a negative refractive power in the rear lens group LR. By disposing the lens unit Ln having a negative refractive power at a position close to an image pickup surface, the zoom lens can be made to have a telephoto type arrangement, and it becomes easier to reduce the total length of the zoom lens.

The conditional expression (9) is for reducing the total lens length of the zoom lens. When fn/ft falls below the lower limit value of the conditional expression (9) and the negative refractive power of the lens unit Ln having a negative refractive power becomes too small, it becomes difficult to reduce the total lens length. When fn/ft exceeds the upper limit value of the conditional expression (9) and the negative refractive power of the lens unit Ln having a negative refractive power becomes too large, the curvature of field increases at a telephoto end.

More preferably, the numerical range of the conditional expression (9) is set to the following range.

−0.50<fn/ft<−0.19 (9a)

Even more preferably, the numerical range of the conditional expression (9a) is set to the following range.

−0.47<fn/ft<−0.21 (9b)

Thus far, exemplary embodiments of the present invention have been described, but the present invention is not limited to these exemplary embodiments, and various modifications and changes can be made within the scope of the spirit of the present invention.

Hereinafter, each of the exemplary embodiments will be described with reference to the appended drawings.

### First Exemplary Embodiment

Hereinafter, the lens configuration of the zoom lens according to the first exemplary embodiment of the present invention will be described with reference to FIG. 1. The first exemplary embodiment includes a first lens unit L1 having a positive refractive power, a second lens unit L2 having a negative refractive power, a third lens unit L3 having a positive refractive power, a fourth lens unit L4 having a positive refractive power, and a fifth lens unit L5 having a negative refractive power, and the first through fifth lens units L1 through L5 are disposed in order from the object side to the image side. The rear lens group LR is constituted by the fourth lens unit L4 having a positive refractive power and the fifth lens unit L5 having a negative refractive power. The first lens unit L1 is stationary when zooming.

The second lens unit L2 and the third lens unit L3 each move toward the image side when zooming from a wide angle end to a telephoto end. The fourth lens unit L4 and the fifth lens unit L5 each move toward the object side. With this configuration, the magnification variation burden is shared among the lens units, a variation in aberrations is reduced in the entire zoom range, and good optical performance is achieved in the entire zoom range.

In particular, the optical arrangement of the third lens unit L3 is disposed more toward the object side at a wide angle end than at a telephoto end, and thus the effective diameter of the front lens is reduced. In addition, the fifth lens unit L5 is moved toward the object side when zooming from a wide angle end to a telephoto end so as to obtain the magnification increasing effect. Thus, a high zoom ratio is achieved and the total lens length is reduced. The first lens unit L1 is made stationary relative to the image plane when zooming so as to simplify the driving mechanism of the lens units, and the lens unit is configured to have a closed structure so as to achieve an image pickup apparatus that is strong against an external disturbance.

The image blurring correction is carried out with the use of the second lens unit L2. By carrying out the image blurring correction with the second lens unit L2, which is the main magnification varying lens unit, it becomes easier to increase the image stabilization sensitivity. In addition, since the second lens unit L2 is disposed behind the first lens unit L1 having a positive refractive power, the lens effective diameter can be reduced, and it becomes easier to reduce the thickness of the zoom lens. The fifth lens unit L5 is the lens unit (Ln) and carries out focusing.

The first lens unit L1 is constituted by a negative lens having a concave surface on the image side, a reflection member constituted by a total reflection prism, and a biconvex positive lens having an aspherical surface. The second lens unit L2 is constituted by a biconcave negative lens having an aspherical surface and a cemented lens in which a biconcave negative lens and a biconvex positive lens are cemented. The third lens unit L3 is constituted by a cemented lens in which a biconvex positive lens having an aspherical surface and a meniscus-shaped negative lens having a concave surface on the object side are cemented.

The fourth lens unit L4 is constituted by a biconvex positive lens having an aspherical surface and a cemented lens in which a biconvex positive lens and a meniscus-shaped negative lens having a concave surface on the object side are cemented. The fifth lens unit L5 is constituted by a cemented lens in which a biconvex positive lens and a biconcave negative lens having an aspherical surface are cemented. By optimizing the refractive power arrangement of the lens units, the lens configuration in each lens unit, the moving loci associated with zooming, and so on, a high zoom ratio is achieved, and the size of the zoom lens is reduced.

### Second Exemplary Embodiment

Hereinafter, the lens configuration of the zoom lens according to the second exemplary embodiment of the present invention will be described with reference to FIG. 4. The second exemplary embodiment includes a first lens unit L1 having a positive refractive power, a second lens unit L2 having a negative refractive power, a third lens unit L3 having a positive refractive power, a fourth lens unit L4 having a positive refractive power, a fifth lens unit L5 having a negative refractive power, and a sixth lens unit L6 having a positive refractive power, and the first through sixth lens units L1 through L6 are disposed in order from the object side to the image side. The rear lens group LR is constituted by the fourth lens unit L4 having a positive refractive power, the fifth lens unit L5 having a negative refractive power, and the sixth lens unit L6 having a positive refractive power. The first lens unit L1 and the sixth lens unit L6 are stationary when zooming.

The second lens unit L2 moves toward the image side when zooming from a wide angle end to a telephoto end. The third lens unit L3 moves along a locus that projects toward the object side. The fourth lens unit L4 and the fifth lens unit L5 each move toward the object side. The image blurring correction is carried out with the use of the second lens unit L2. The fifth lens unit L5 is the lens unit Ln and carries out focusing. The lens configurations of the first lens unit L1 through the fourth lens unit L4 are the same as those of the first exemplary embodiment.

The fifth lens unit L5 is constituted by a cemented lens in which a meniscus-shaped positive lens having a convex surface on the image side and a biconcave negative lens are cemented. The sixth lens unit L6 is constituted by a biconvex positive lens having an aspherical surface.

### Third Exemplary Embodiment

Hereinafter, the lens configuration of the zoom lens according to the third exemplary embodiment of the present invention will be described with reference to FIG. 7. The third exemplary embodiment is the same as the first exemplary embodiment in terms of the number of the lens units, the sign of the refractive power of each lens unit, the movement of each lens unit associated with zooming, and so on. The third exemplary embodiment is the same as the first exemplary embodiment in terms of the image blurring correction and the focusing as well. The first lens unit L1 is constituted by a reflection member constituted by a total reflection prism having a concave surface on the object side and a biconvex positive lens having an aspherical surface. By constituting the surface of the reflection member on the object side by a surface having a negative refractive power, a negative lens to be disposed toward the front side of the reflection member is omitted, and the thickness of the lens system is reduced.

Here, when the refractive index of the reflection member with respect to the d-line is represented by Ndn and the radius of curvature of the surface having a concave shape is represented by rn, the focal length fGn of the lens component having a negative refractive power constituted by the concave surface of the reflection member on the object side can be obtained through the following expression.

fGn=1/((Ndn−1)×(1/rn))

The second lens unit L2 is constituted by a meniscus-shaped negative lens having a concave aspherical surface on the image side and a cemented lens in which a biconcave negative lens and a biconvex positive lens are cemented. The lens configurations of the third lens unit L3 and the fourth lens unit L4 are the same as those of the first exemplary embodiment. The fifth lens unit L5 is constituted by a cemented lens in which a meniscus-shaped positive lens having a convex surface on the object side and a meniscus-shaped negative lens having a concave surface on the image side are cemented.

### Fourth Exemplary Embodiment

Hereinafter, the lens configuration of the zoom lens according to the fourth exemplary embodiment of the present invention will be described with reference to FIG. 10. The fourth exemplary embodiment includes a first lens unit L1 having a positive refractive power, a second lens unit L2 having a negative refractive power, a third lens unit L3 having a positive refractive power, and a fourth lens unit L4 having a positive refractive power, and the first through fourth lens units L1 through L4 are disposed in order from the object side to the image side. The rear lens group LR is constituted by the fourth lens unit L4 having a positive refractive power. The first lens unit L1 is stationary when zooming.

The second lens unit L2 and the third lens unit L3 each move toward the image side when zooming from a wide angle end to a telephoto end. The fourth lens unit L4 moves toward the object side. The image blurring correction is carried out with the use of the second lens unit L2. The focusing is carried out with a partial unit Lf having a negative refractive power that is constituted by a portion of the fourth lens unit L4. The lens configuration of the first lens unit L1 is the same as that of the first exemplary embodiment. The second lens unit L2 is constituted by a biconcave negative lens having an aspherical surface and a cemented lens in which a biconcave negative lens and a meniscus-shaped positive lens having a convex surface on the object side are cemented. The third lens unit L3 is constituted by a biconvex positive lens having an aspherical surface.

The fourth lens unit L4 is constituted by a biconvex positive lens having an aspherical surface, a cemented lens in which a biconvex positive lens and a meniscus-shaped negative lens having a concave surface on the object side are cemented, and a cemented lens in which a meniscus-shaped positive lens having a convex surface on the image side and a biconcave negative lens having an aspherical surface are cemented. In each of the exemplary embodiments described above, the distortion aberration may also be corrected electronically by applying various well-known techniques.

Thus far, exemplary embodiments of the present invention have been described, but the present invention is not limited to these exemplary embodiments, and various modifications and changes can be made within the scope of the spirit of the present invention.

FIG. 13 illustrates a state in which the optical path is bent by 90 degrees by the reflection member PR at a wide angle end of the zoom lens according to the first exemplary embodiment illustrated in FIG. 1, and the reference characters appended to the components, the movement when zooming, and so on are the same as those of FIG. 1.

Next, an exemplary embodiment of a digital still camera in which a zoom lens such as the one illustrated in each of the exemplary embodiments is used as an image pickup optical system will be described with reference to FIG. 14. Illustrated in FIG. 14 are a camera main body 20 and an image pickup optical system 21 that is constituted by the zoom lens described in any one of the first through fourth exemplary embodiments.

A solid-state image pickup element (photoelectric conversion element) 22 is embedded in the camera main body and is constituted by a CCD sensor, a CMOS sensor, or the like that receives an object image formed by the image pickup optical system 21. A memory 23 records information corresponding to the object image that has been subjected to photoelectric conversion by the solid-state image pickup element 22. A finder 24 is constituted by a liquid-crystal display panel or the like and is used to observe the object image formed on the solid-state image pickup element 22. In this manner, by applying the zoom lens according to an exemplary embodiment of the present invention to an image pickup apparatus, such as a digital still camera, an image pickup apparatus that is small in size and that has high optical performance is achieved.

Next, first through fourth numerical data examples corresponding, respectively, to the first through fourth exemplary embodiments of the present invention are tabulated below. In each of the numerical data examples, i indicates the order of a given optical surface counted from the object side. In addition, ri represents the radius of curvature of an ith optical surface (ith surface), di represents the distance between an ith surface and an (i+1)th surface, ndi and νdi represent the refractive index and the Abbe number, respectively, of the material for an ith optical member with respect to the d-line.

Furthermore, in each example, certain surfaces are aspherical surfaces. An aspherical surface is denoted by an asterisk (*) next to the surface number. In the data for aspherical surfaces, k represents the eccentricity, A4, A6, and A8 represent the aspherical coefficients, and the displacement in the optical axis direction at the position of a height h from the optical axis is represented by x with the surface vertex serving as a reference. In this case, the aspherical shape is expressed by the following expression.

x=(h²/R)/[1+[1−(1+k)(h/R)²]^{1/2}]+A4h⁴+A6h⁶+A8h⁸

Here, R is the radius of paraxial curvature. In addition, the expression “E-Z” means “10^{-Z}.”

The last two surfaces in each of the first through fourth numerical data examples are surfaces of an optical block, such as a filter or a face plate. In each of the numerical data examples, the back focus (BF) is the distance from the final lens surface to the paraxial image plane expressed in terms of the air-equivalent length. The total lens length is obtained by adding the back focus in the air-equivalent length to the distance from the lens surface closest to the object side to the final lens surface. In addition, the correspondence between the numerical data of each example and the conditional expressions described above is summarized in Table 1.

### First Numerical Data Example

unit: mm
surface data

| | | | | | effective |
|---|---|---|---|---|---|
| surface number | r | d | nd | νd | diameter |
| 1 | 15.075 | 0.30 | 2.00272 | 19.3 | 7.30 |
| 2 | 6.637 | 1.00 | | | 6.60 |
| 3 | ∞ | 5.00 | 2.10205 | 16.8 | 6.50 |
| 4 | ∞ | 0.10 | | | 5.55 |
| 5* | 8.027 | 1.52 | 1.80400 | 46.6 | 5.65 |
| 6* | −17.264 | (variable) | | | 5.47 |
| 7* | −6.787 | 0.30 | 1.85135 | 40.1 | 3.25 |
| 8* | 5.218 | 0.35 | | | 2.90 |
| 9 | −21.265 | 0.30 | 1.83481 | 42.7 | 2.86 |
| 10 | 5.268 | 0.88 | 1.92286 | 18.9 | 2.77 |
| 11 | −23.349 | (variable) | | | 2.64 |
| 12* | 6.845 | 1.10 | 1.49710 | 81.6 | 2.63 |
| 13 | −5.080 | 0.30 | 1.91082 | 35.3 | 2.75 |
| 14 | −11.554 | (variable) | | | 2.92 |
| 15* | 15.525 | 1.95 | 1.55332 | 71.7 | 6.21 |
| 16 | −9.064 | 0.10 | | | 6.51 |
| 17 | 16.444 | 2.35 | 1.53775 | 74.7 | 6.51 |
| 18 | −6.913 | 0.29 | 2.00069 | 25.5 | 6.34 |
| 19 | −10.927 | (variable) | | | 6.41 |
| 20 | 58.443 | 1.24 | 1.69895 | 30.1 | 4.97 |
| 21 | −7.437 | 0.30 | 1.90270 | 31.0 | 4.78 |
| 22* | 9.142 | (variable) | | | 4.63 |
| 23 | ∞ | 0.25 | 1.55671 | 58.6 | 8.00 |
| 24 | ∞ | 0.50 | | | 8.00 |
| image plane | ∞ | | | | |

aspherical surface data

5th surface
K = 0.00000e+000 A4 = −1.88037e−004 A6 = −1.73403e−007
A8 = −1.05807e−007
6th surface
K = 0.00000e+000 A4 = 9.29714e−005
7th surface
K = 0.00000e+000 A4 = 2.44483e−003
8th surface
K = 0.00000e+000 A4 = −1.09850e−003 A6 = 2.74774e−004
A8 = −2.71004e−005
12th surface
K = 0.00000e+000 A4 = −1.00335e−003 A6 = 4.77786e−005
15th surface
K = 0.00000e+000 A4 = −6.49254e−004 A6 = 5.34648e−006
A8 = −1.70166e−007
22nd surface
K = 0.00000e+000 A4 = 8.18814e−004 A6 = 4.71103e−005
A8 = −4.48221e−006

various pieces of data
zoom ratio 4.73

| | wide angle | intermediate | telephoto |
|---|---|---|---|
| focal length | 4.08 | 9.24 | 19.30 |
| F-number | 3.60 | 4.78 | 5.73 |
| half angle of view (degree) | 33.50 | 17.99 | 8.84 |
| image height | 2.70 | 3.00 | 3.00 |
| total lens length | 33.01 | 33.01 | 33.01 |
| BF | 3.27 | 5.77 | 8.27 |
| d6 | 0.30 | 2.99 | 5.67 |
| d11 | 3.74 | 1.58 | 0.30 |
| d14 | 5.19 | 2.49 | 0.10 |
| d19 | 3.06 | 2.73 | 1.21 |
| d22 | 2.61 | 5.11 | 7.61 |
| entrance pupil position | 5.38 | 8.18 | 13.26 |
| exit pupil position | −12.39 | −11.41 | −11.82 |
| front principal point position | 8.17 | 10.25 | 2.32 |
| rear principal point position | −3.58 | −8.74 | −18.80 |

zoom lens unit data

| | | | | front princi- | rear princi- |
|---|---|---|---|---|---|
| | starting | focal | lens config- | pal point | pal point |
| unit | surface | length | uration length | position | position |
| 1 | 1 | 9.72 | 7.92 | 5.32 | 2.34 |
| 2 | 7 | −3.79 | 1.83 | −0.04 | −1.22 |
| 3 | 12 | 14.24 | 1.40 | 0.16 | −0.75 |
| 4 | 15 | 7.02 | 4.68 | 1.41 | −1.79 |
| 5 | 20 | −8.82 | 1.54 | 0.95 | 0.06 |
| GB | 23 | ∞ | 0.25 | 0.08 | −0.08 |

single lens data

| lens | starting surface | focal length |
|---|---|---|
| 1 | 1 | −12.04 |
| 2 | 3 | 0.00 |
| 3 | 5 | 7.00 |
| 4 | 7 | −3.43 |
| 5 | 9 | −5.03 |
| 6 | 10 | 4.73 |
| 7 | 12 | 6.05 |
| 8 | 13 | −10.18 |
| 9 | 15 | 10.64 |
| 10 | 17 | 9.38 |
| 11 | 18 | −19.50 |
| 12 | 20 | 9.51 |
| 13 | 21 | −4.50 |
| 14 | 23 | 0.00 |

### Second Numerical Data Example

unit: mm
surface data

| | | | | | effective |
|---|---|---|---|---|---|
| surface number | r | d | nd | νd | diameter |
| 1 | 17.150 | 0.30 | 2.00272 | 19.3 | 7.31 |
| 2 | 6.441 | 1.00 | | | 6.57 |
| 3 | ∞ | 5.00 | 2.10205 | 16.8 | 6.50 |
| 4 | ∞ | 0.10 | | | 5.35 |
| 5* | 7.612 | 1.49 | 1.80400 | 46.6 | 5.47 |
| 6* | −15.434 | (variable) | | | 5.31 |
| 7* | −6.937 | 0.30 | 1.85135 | 40.1 | 3.66 |
| 8* | 5.321 | 0.43 | | | 3.28 |
| 9 | −16.646 | 0.30 | 1.83481 | 42.7 | 3.24 |
| 10 | 7.189 | 0.93 | 1.92286 | 18.9 | 3.18 |
| 11 | −14.752 | (variable) | | | 3.10 |
| 12* | 5.509 | 1.14 | 1.49710 | 81.6 | 2.93 |
| 13 | −10.034 | 0.30 | 1.91082 | 35.3 | 2.91 |
| 14 | −365.274 | (variable) | | | 3.03 |
| 15* | 11.097 | 1.87 | 1.55332 | 71.7 | 5.00 |
| 16 | −8.397 | 0.10 | | | 5.25 |
| 17 | 16.766 | 1.95 | 1.53775 | 74.7 | 5.22 |
| 18 | −6.737 | 0.29 | 2.00069 | 25.5 | 5.06 |
| 19 | −11.605 | (variable) | | | 5.10 |
| 20 | −5.519 | 0.89 | 1.58144 | 40.8 | 4.00 |
| 21 | −3.696 | 0.30 | 1.91082 | 35.3 | 4.07 |
| 22 | 50.295 | (variable) | | | 4.37 |
| 23* | 9.399 | 1.28 | 1.58313 | 59.4 | 5.90 |
| 24 | −29.052 | 0.50 | | | 5.96 |
| 25 | ∞ | 0.25 | 1.55671 | 58.6 | 8.00 |
| 26 | ∞ | 0.50 | | | 8.00 |
| image plane | ∞ | | | | |

aspherical surface data

5th surface
K = 0.00000e+000 A4 = −2.95274e−004 A6 = −2.30722e−007
A8 = −1.63628e−007
6th surface
K = 0.00000e+000 A4 = 1.00869e−004
7th surface
K = 0.00000e+000 A4 = 2.17837e−003
8th surface
K = 0.00000e+000 A4 = −1.41815e−003 A6 = 2.74392e−004
A8 = −2.93736e−005
12th surface
K = 0.00000e + 000 A4 = −1.65560e−003 A6 = 5.17822e−006
15th surface
K = 0.00000e+000 A4 = −6.92983e−004 A6 = 2.31615e−005
A8 = −1.30973e−006
23rd surface
K = 0.00000e+000 A4 = −9.57010e−006 A6 = 4.25617e−005
A8 = −3.61557e−006

various pieces of data
zoom ratio 4.73

| | wide angle | intermediate | telephoto |
|---|---|---|---|
| focal length | 4.08 | 9.41 | 19.30 |
| F-number | 3.60 | 4.83 | 5.73 |
| half angle of view (degree) | 33.50 | 17.68 | 8.84 |
| image height | 2.70 | 3.00 | 3.00 |
| total lens length | 32.10 | 32.10 | 32.10 |
| BF | 1.16 | 1.16 | 1.16 |
| d6 | 0.30 | 2.72 | 5.14 |
| d11 | 4.94 | 2.01 | 0.30 |
| d14 | 3.18 | 1.66 | 0.10 |
| d19 | 3.74 | 4.01 | 3.10 |
| d22 | 0.70 | 2.46 | 4.23 |
| entrance pupil position | 5.37 | 7.67 | 11.42 |
| exit pupil position | −10.61 | −15.26 | −22.38 |
| front principal point position | 7.95 | 11.46 | 14.45 |
| rear principal point position | −3.58 | −8.91 | −18.80 |

zoom lens unit data

| | | | | front princi- | rear princi- |
|---|---|---|---|---|---|
| | starting | focal | lens config- | pal point | pal point |
| unit | surface | length | uration length | position | position |
| 1 | 1 | 9.00 | 7.89 | 5.30 | 2.59 |
| 2 | 7 | −4.11 | 1.97 | −0.14 | −1.47 |
| 3 | 12 | 18.47 | 1.44 | −0.54 | −1.42 |
| 4 | 15 | 6.51 | 4.21 | 1.15 | −1.72 |
| 5 | 20 | −4.56 | 1.19 | 0.29 | −0.41 |
| 6 | 23 | 12.33 | 1.28 | 0.20 | −0.62 |
| GB | 25 | ∞ | 0.25 | 0.08 | −0.08 |

single lens data

| lens | starting surface | focal length |
|---|---|---|
| 1 | 1 | −10.43 |
| 2 | 3 | 0.00 |
| 3 | 5 | 6.53 |
| 4 | 7 | −3.50 |
| 5 | 9 | −5.98 |
| 6 | 10 | 5.35 |
| 7 | 12 | 7.33 |
| 8 | 13 | −11.33 |
| 9 | 15 | 8.95 |
| 10 | 17 | 9.20 |
| 11 | 18 | −16.54 |
| 12 | 20 | 16.31 |
| 13 | 21 | −3.77 |
| 14 | 23 | 12.33 |
| 15 | 25 | 0.00 |

### Third Numerical Data Example

unit: mm
surface data

| | | | | | effective |
|---|---|---|---|---|---|
| surface number | r | d | nd | νd | diameter |
| 1 | −19.877 | 6.00 | 2.10205 | 16.8 | 7.50 |
| 2 | ∞ | 0.10 | | | 5.57 |
| 3* | 9.698 | 1.37 | 1.80400 | 46.6 | 5.58 |
| 4* | −16.433 | (variable) | | | 5.39 |
| 5* | 177.699 | 0.30 | 1.85135 | 40.1 | 3.43 |
| 6* | 4.110 | 0.66 | | | 2.93 |
| 7 | −5.367 | 0.30 | 1.83481 | 42.7 | 2.76 |
| 8 | 5.001 | 0.94 | 1.92286 | 18.9 | 2.63 |
| 9 | −16.137 | (variable) | | | 2.49 |
| 10* | 5.600 | 0.99 | 1.49710 | 81.6 | 2.44 |
| 11 | −4.898 | 0.30 | 1.91082 | 35.3 | 2.71 |
| 12 | −16.778 | (variable) | | | 2.89 |
| 13* | 11.381 | 2.23 | 1.55332 | 71.7 | 7.00 |
| 14 | −6.781 | 0.10 | | | 7.31 |
| 15 | 19.500 | 2.74 | 1.53775 | 74.7 | 7.15 |
| 16 | −6.889 | 0.29 | 2.00069 | 25.5 | 6.85 |
| 17 | −10.215 | (variable) | | | 6.92 |
| 18 | 7.139 | 0.89 | 1.69895 | 30.1 | 5.53 |
| 19 | 14.551 | 0.30 | 1.90270 | 31.0 | 5.16 |
| 20* | 3.617 | (variable) | | | 4.60 |
| 21 | ∞ | 0.25 | 1.55671 | 58.6 | 8.00 |
| 22 | ∞ | 0.50 | | | 8.00 |
| image plane | ∞ | | | | |

aspherical surface data

3rd surface
K = 0.00000e+000 A4 = −1.03137e−004 A6 = 1.42851e−006
A8 = 1.22359e−008
4th surface
K = 0.00000e+000 A4 = 3.14783e−004
5th surface
K = 0.00000e+000 A4 = 5.04769e−003
6th surface
K = 0.00000e+000 A4 = 4.91166e−003 A6 = 1.13540e−004
A8 = 2.64983e−004
10th surface
K = 0.00000e+000 A4 = −1.28945e−003 A6 = 5.22529e−005
13th surface
K = 0.00000e+000 A4 = −1.72826e−003 A6 = 1.95311e−005
A8 = −3.66710e−007
20th surface
K = 0.00000e+000 A4 = 3.33549e−004 A6 = 3.08899e−005
A8 = −8.97295e−006

various pieces of data
zoom ratio 4.73

| | wide angle | intermediate | telephoto |
|---|---|---|---|
| focal length | 4.08 | 8.79 | 19.30 |
| F-number | 3.38 | 4.55 | 5.96 |
| half angle of view (degree) | 33.50 | 18.85 | 8.84 |
| image height | 2.70 | 3.00 | 3.00 |
| total lens length | 32.32 | 32.32 | 32.32 |
| BF | 4.53 | 6.83 | 9.14 |
| d4 | 0.30 | 2.69 | 5.08 |
| d9 | 3.08 | 1.47 | 0.30 |
| d12 | 5.60 | 2.83 | 0.10 |
| d17 | 1.21 | 0.90 | 0.10 |
| d20 | 3.87 | 6.17 | 8.48 |
| entrance pupil position | 5.56 | 8.72 | 14.08 |
| exit pupil position | −18.48 | −12.82 | −12.11 |
| front principal point position | 8.76 | 11.71 | 3.85 |
| rear principal point position | −3.58 | −8.29 | −18.80 |

zoom lens unit data

| | | | | front princi- | rear princi- |
|---|---|---|---|---|---|
| | starting | focal | lens config- | pal point | pal point |
| unit | surface | length | uration length | position | position |
| 1 | 1 | 10.37 | 7.47 | 4.33 | 1.38 |
| 2 | 5 | −3.58 | 2.21 | 0.20 | −1.33 |
| 3 | 10 | 16.59 | 1.29 | −0.18 | −1.00 |
| 4 | 13 | 5.94 | 5.35 | 1.58 | −2.16 |
| 5 | 18 | −8.25 | 1.19 | 1.34 | 0.57 |
| GB | 21 | ∞ | 0.25 | 0.08 | −0.08 |

single lens data

| lens | starting surface | focal length |
|---|---|---|
| 1 | 1 | −18.04 |
| 2 | 3 | 7.77 |
| 3 | 5 | −4.95 |
| 4 | 7 | −3.06 |
| 5 | 8 | 4.23 |
| 6 | 10 | 5.43 |
| 7 | 11 | −7.69 |
| 8 | 13 | 8.03 |
| 9 | 15 | 9.82 |
| 10 | 16 | −22.10 |
| 11 | 18 | 19.11 |
| 12 | 19 | −5.40 |
| 13 | 21 | 0.00 |

### Fourth Numerical Data Example

unit: mm
surface data

| | | | | | effective |
|---|---|---|---|---|---|
| surface number | r | d | nd | νd | diameter |
| 1 | 17.764 | 0.30 | 2.00069 | 25.5 | 6.93 |
| 2 | 5.538 | 0.97 | | | 6.13 |
| 3 | ∞ | 5.00 | 2.00100 | 29.1 | 6.10 |
| 4 | ∞ | 0.10 | | | 5.46 |
| 5* | 7.438 | 1.70 | 1.62263 | 58.2 | 5.48 |
| 6* | −8.681 | (variable) | | | 5.27 |
| 7* | −9.896 | 0.30 | 1.85135 | 40.1 | 3.35 |
| 8* | 7.489 | 0.28 | | | 3.07 |
| 9 | −30.503 | 0.30 | 1.88300 | 40.8 | 3.02 |
| 10 | 4.447 | 0.93 | 1.89286 | 20.4 | 2.89 |
| 11 | 141.032 | (variable) | | | 2.73 |
| 12* | 9.553 | 0.80 | 1.49710 | 81.6 | 3.03 |
| 13 | −52.462 | (variable) | | | 3.07 |
| 14* | 9.398 | 2.21 | 1.55332 | 71.7 | 6.00 |
| 15 | −14.050 | 2.27 | | | 6.15 |
| 16 | 13.199 | 2.23 | 1.49700 | 81.5 | 5.89 |
| 17 | −5.201 | 0.29 | 2.00272 | 19.3 | 5.67 |
| 18 | −9.783 | 3.51 | | | 5.79 |
| 19 | −10.738 | 1.43 | 1.76182 | 26.5 | 4.65 |
| 20 | −3.774 | 0.30 | 1.85135 | 40.1 | 4.68 |
| 21* | 38.557 | (variable) | | | 4.81 |
| 22 | ∞ | 0.25 | 1.55671 | 58.6 | 10.00 |
| 23 | ∞ | 0.50 | | | 10.00 |
| image plane | ∞ | | | | |

aspherical surface data

5th surface
K = 0.00000e+000 A4 = −2.90817e−004 A6 = 1.28446e−007
A8 = −2.81520e−007
6th surface
K = 0.00000e+000 A4 = 3.83334e−004
7th surface
K = 0.00000e+000 A4 = 2.61005e−004
8th surface
K = 0.00000e+000 A4 = −1.19863e−003 A6 = 3.78336e−004
A8 = −7.75181e−005
12th surface
K = 0.00000e+000 A4 = −5.53989e−004 A6 = −6.66087e−005
A8 = 1.83006e−005
14th surface
K = 0.00000e+000 A4 = −3.13885e−004 A6 = 1.92713e−005
A8 = −6.32517e−007
21st surface
K = 0.00000e+000 A4 = 5.36044e−004 A6 = 3.93258e−005
A8 = −3.67612e−006

various pieces of data
zoom ratio 4.73

| | | | |
|---|---|---|---|
| focal length | 4.08 | 8.06 | 19.30 |
| F-number | 3.60 | 4.58 | 6.37 |
| half angle of view (degree) | 33.50 | 20.41 | 8.84 |
| image height | 2.70 | 3.00 | 3.00 |
| total lens length | 35.00 | 35.00 | 35.00 |
| BF | 2.00 | 3.58 | 5.50 |
| d6 | 0.30 | 3.19 | 6.09 |
| d11 | 4.50 | 2.72 | 0.30 |
| d13 | 5.19 | 2.50 | 0.10 |
| d21 | 1.34 | 2.92 | 4.84 |
| entrance pupil position | 4.89 | 7.27 | 10.18 |
| exit pupil position | −9.97 | −9.62 | −10.46 |
| front principal point position | 7.38 | 8.91 | −4.51 |
| rear principal point position | −3.58 | −7.56 | −18.80 |

zoom lens unit data

| | | | | front princi- | rear princi- |
|---|---|---|---|---|---|
| | starting | focal | lens config- | pal point | pal point |
| unit | surface | length | uration length | position | position |
| 1 | 1 | 10.03 | 8.07 | 6.21 | 4.35 |
| 2 | 7 | −4.21 | 1.81 | 0.16 | −0.92 |
| 3 | 12 | 16.33 | 0.80 | 0.08 | −0.45 |
| 4 | 14 | 8.42 | 12.24 | −6.00 | −8.73 |
| GB | 22 | ∞ | 0.25 | 0.08 | −0.08 |

single lens data

| lens | starting surface | focal length |
|---|---|---|
| 1 | 1 | −8.14 |
| 2 | 3 | 0.00 |
| 3 | 5 | 6.71 |
| 4 | 7 | −4.97 |
| 5 | 9 | −4.38 |
| 6 | 10 | 5.13 |
| 7 | 12 | 16.33 |
| 8 | 14 | 10.53 |
| 9 | 16 | 7.82 |
| 10 | 17 | −11.43 |
| 11 | 19 | 7.01 |
| 12 | 20 | −4.02 |
| 13 | 22 | 0.00 |

TABLE 1

| | | First | Second | Third | Fourth |
|---|---|---|---|---|---|
| | | Numerical | Numerical | Numerical | Numerical |
| | | Example | Example | Example | Example |
| Conditional | β2t | −1.43 | −1.65 | −1.24 | −1.07 |
| Expression (1) | | | | | |
| Conditional | D23w/ | 0.92 | 1.21 | 0.76 | 1.10 |
| Expression (2) | fw | | | | |
| Conditional | D1/ft | 0.41 | 0.41 | 0.39 | 0.42 |
| Expression (3) | | | | | |
| Conditional | f1/fw | 2.38 | 2.20 | 2.54 | 2.46 |
| Expression (4) | | | | | |
| Conditional | f2/fw | −0.93 | −1.01 | −0.88 | −1.03 |
| Expression (5) | | | | | |
| Conditional | Z2/Z | 0.64 | 0.62 | 0.56 | 0.52 |
| Expression (6) | | | | | |
| Conditional | fGn/Dpr | −2.41 | −2.09 | −3.01 | −1.63 |
| Expression (7) | | | | | |
| Conditional | Ndpr | 2.102 | 2.102 | 2.102 | 2.001 |
| Expression (8) | | | | | |
| Conditional | fn/ft | −0.46 | −0.24 | −0.43 | — |
| Expression (9) | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-251330 filed Dec. 24, 2015, which is hereby incorporated by reference herein in its entirety.

What is claimed is:

1. A zoom lens, comprising:
a first lens unit having a positive refractive power;
a second lens unit having a negative refractive power;
a third lens unit having a positive refractive power; and
a rear lens group having one or more lens units, the first through third lens units and the rear lens group being disposed in this order from an object side to an image side,
wherein the first lens unit is stationary when zooming,
wherein a distance between adjacent lens units changes when zooming,
wherein a reflection member including a reflective surface configured to bend an optical path is disposed in an optical path of the first lens unit,
wherein the second lens unit moves in a direction having a component in a direction perpendicular to an optical axis when correcting image blurring, and
wherein the following conditional expression is satisfied
−2.50<β2t<−0.98,
where β2t represents a lateral magnification of the second lens unit when being focused at infinity at a telephoto end.

2. The zoom lens according to claim 1,
wherein the following conditional expression is satisfied
0.50<D23w/fw<1.50,
where D23w represents a distance from a lens surface of the second lens unit that is closest to the image side at a wide angle end to a lens surface of the third lens unit that is closest to the object side along the optical axis, and fw represents a focal length of the zoom lens at the wide angle end.

3. The zoom lens according to claim 1,
wherein the following conditional expression is satisfied
0.20<D1/ft<0.50,
where D1 represents a distance from a lens surface of the first lens unit that is closest to the object side to a lens surface of the first lens unit that is closest to the image side along the optical axis, and ft represents a focal length of the zoom lens at the telephoto end.

4. The zoom lens according to claim 1,
wherein the following conditional expression is satisfied
2.00<f1/fw<3.00,
where f1 represents a focal length of the first lens unit, and the fw represents a focal length of the zoom lens at a wide angle end.

5. The zoom lens according to claim 1,
wherein the following conditional expression is satisfied
−1.30<f2/fw<−0.60,
where f2 represents a focal length of the second lens unit, and the fw represents a focal length of the zoom lens at a wide angle end.

6. The zoom lens according to claim 1,
wherein the following conditional expression is satisfied
0.46<Z2/Z<0.72,
where Z2=β2t/β2w and Z=ft/fw hold true, and
where β2w represents a lateral magnification of the second lens unit when being focused at infinity at a wide angle end, fw represents a focal length of the zoom lens at the wide angle end, and ft represents a focal length of the zoom lens at the telephoto end.

7. The zoom lens according to claim 1,
wherein the first lens unit consists of a lens component having a negative refractive power, a reflection member, and a lens component having a positive refractive power that are disposed in order from the object side to the image side or consists of a reflection member having a negative refractive power and a lens component having a positive refractive power that are disposed in order from the object side to the image side.

8. The zoom lens according to claim 1,
wherein the reflection member consists of a prism.

9. The zoom lens according to claim 7,
wherein the following conditional expression is satisfied
−3.50<fGn/Dpr<−1.20,
where fGn represents a focal length of the lens component having a negative refractive power, the reflection member consists of a prism, and Dpr represents a length of the prism along the optical axis.

10. The zoom lens according to claim 1,
wherein the following conditional expression is satisfied
1.80<Ndpr<2.50,
where the reflection member consists of a prism, and Ndpr represents a refractive index of a material for the prism at a d-line.

11. The zoom lens according to claim 1,
wherein the rear lens group includes a lens unit having a negative refractive power.

12. The zoom lens according to claim 11,
wherein the following conditional expression is satisfied
−0.53<fn/ft<−0.17,
where fn represents a focal length of the lens unit having a negative refractive power included in the rear lens group, and ft represents a focal length of the zoom lens at the telephoto end.

13. The zoom lens according to claim 1,
wherein the rear lens group consists of a fourth lens unit having a positive refractive power.

14. The zoom lens according to claim 1,
wherein the rear lens group consists of a fourth lens unit having a positive refractive power and a fifth lens unit having a negative refractive power that are disposed in order from the object side to the image side.

15. The zoom lens according to claim 1,
wherein the rear lens group consists of a fourth lens unit having a positive refractive power, a fifth lens unit having a negative refractive power, and a sixth lens unit having a positive refractive power that are disposed in order from the object side to the image side.

16. An image pickup apparatus, comprising:
the zoom lens according to claim 1; and
a solid-state image pickup element configured to receive an image formed by the zoom lens.
